(19) United States
(12) Patent Application Publication
(10) Pub. No.: US 2023/0027881 A1
(43) Pub. Date: Jan. 26, 2023

(54) METHOD FOR SINTERING CERAMIC GREEN BODY AT ROOM TEMPERATURE AND CERAMIC

(71) Applicant: Tsinghua Shenzhen International Graduate School, Shenzhen (CN)

(72) Inventors: XI-LIN WANG, Shenzhen (CN); JIE-MING LIU, Shenzhen (CN); GUANG-HUA LIU, Shenzhen (CN); ZHI-DONG JIA, Shenzhen (CN); RUO-BING ZHANG, Shenzhen (CN); LI-MING WANG, Shenzhen (CN)

(21) Appl. No.: 17/957,222

(22) Filed: Sep. 30, 2022

(30) Foreign Application Priority Data
Apr. 3, 2020 (CN) 2020-10258792.8
Apr. 3, 2020 (CN) 202010258792.8

(51) Int. Cl. C04B 35/64

(52) U.S. Cl. CPC C04B 35/64; C04B 2235/666

(57) ABSTRACT

A method for achieving sintering of ceramics at room temperature is disclosed. The method includes steps of: providing ceramic green body; placing the ceramic green body into a sealed container containing water vapor to cause the ceramic green body to soak up the water vapor to obtain an aqueous ceramic green body; removing the aqueous ceramic green body from the sealed container, and connecting a power supply to the aqueous ceramic green body; applying a voltage to the aqueous ceramic green body; and increasing the voltage to a predetermined voltage value to cause a surface discharge or an internal discharge to occur on the aqueous ceramic green body, and stopping the power supply after a predetermined time, thereby obtaining a ceramic. A ceramic formed by the method is also disclosed.

### FIELD

The subject matter relates to field of preparation of ceramic materials, and more particularly, to a method for sintering a green body at room temperature and a ceramic manufactured by the method.

### BACKGROUND

Human beings have used ceramic materials for thousands of years. From the earliest pottery to today's ceramic materials and devices with diversified functions, ceramic materials are now widely used in various high-tech industries. Because of its special physical and chemical properties, ceramic materials cannot be manufactured by mechanical processing or casting process, but by powder molding and high-temperature sintering. One of main disadvantages of sintering is that it requires a large amount of energy, because a conventional sintering method requires a high temperature over a long time.

In a flash sintering process, by applying a certain strength of electric field on a ceramic green body, a temperature required for sintering can be reduced, and densification of ceramics can be obtained in a very short time. However, a common flash sintering of ceramics still requires a relatively high temperature.

### SUMMARY

In view of this, the present disclosure provides a method of sintering a ceramic green body at room temperature to overcome the above shortcomings.

The present disclosure also provides a ceramic manufactured by the method.

The present disclosure provides a method, comprising the following steps:

providing a ceramic green body;

placing the ceramic green body into a sealed container containing water vapor to cause the ceramic green body to soak up the water vapor, thereby obtaining an aqueous ceramic green body;

removing the aqueous ceramic green body from the sealed container, and connecting a power supply to the aqueous ceramic green body;

applying a voltage to the aqueous ceramic green body; and

increasing the voltage to a predetermined voltage value to cause a surface discharge or an internal discharge to occur on the aqueous ceramic green body, and stopping the power supply after a predetermined time, thereby obtaining a ceramic.

The present disclosure also provides a method, comprising the following steps:

providing a ceramic green body;

placing the ceramic green body into a sealed container containing liquid, evaporating the liquid to cause the ceramic green body to absorb liquid vapor, thereby obtaining a liquid containing ceramic green body;

removing the liquid containing ceramic green body from the sealed container, and connecting a power supply to the liquid containing ceramic green body;

applying a voltage to the liquid containing ceramic green body; and

increasing the voltage to a predetermined voltage value to cause a surface discharge or an internal discharge to occur on the liquid containing ceramic green body, and stopping the power supply after a predetermined time, thereby obtaining a ceramic.

The present disclosure also provides a ceramic manufactured by the method, a grain size of the ceramic is in a range of 500 nm to 10 μm, and a density of the ceramic is greater than 90%.

The method provided by the present disclosure realizes the sintering of ceramic green bodies at room temperature (0° C. to 30° C.) by controlling a moisture content of the ceramic green body, greatly reducing the temperature and energy consumption required for sintering, thereby reducing the energy input required. Meanwhile, the process of the method described in the present disclosure is relatively simple. Compared with the conventional flash sintering process, no additional heating device is required, and the method of controlling the moisture content of the ceramic green body is simple and easy.

### BRIEF DESCRIPTION OF THE DRAWINGS

FIG. 1 is a flowchart of a method for manufacturing a ceramic at room temperature according to an embodiment of the present disclosure.

FIG. 2 is a schematic structural diagram of a water absorption device for ceramic green bodies according to an embodiment of the present disclosure.

FIG. 3 is a schematic structural diagram of a device for sintering ceramics according to an embodiment of the present disclosure.

### DETAILED DESCRIPTION

The technical solutions in the implementations of the present disclosure will be described clearly and completely in combination with the accompanying drawings in the implementations of the present disclosure. Obviously, the described implementations are only part of the implementations of the present disclosure, rather than all the implementations. Based on the implementations in the present disclosure, all other implementations obtained by those of ordinary skill in the art without making creative work fall within the protection scope of the present disclosure.

Unless otherwise defined, all technical and scientific terms used herein have the same meaning as those commonly understood by those skilled in the art of the present disclosure. The terms used in the description of the present disclosure are only for the purpose of describing the specific implementations, and are not intended to limit the present disclosure.

In order to further elaborate the technical means and effects adopted by the present disclosure to achieve the intended purpose, the following detailed description is given in the present disclosure in combination with the drawings and preferred embodiments.

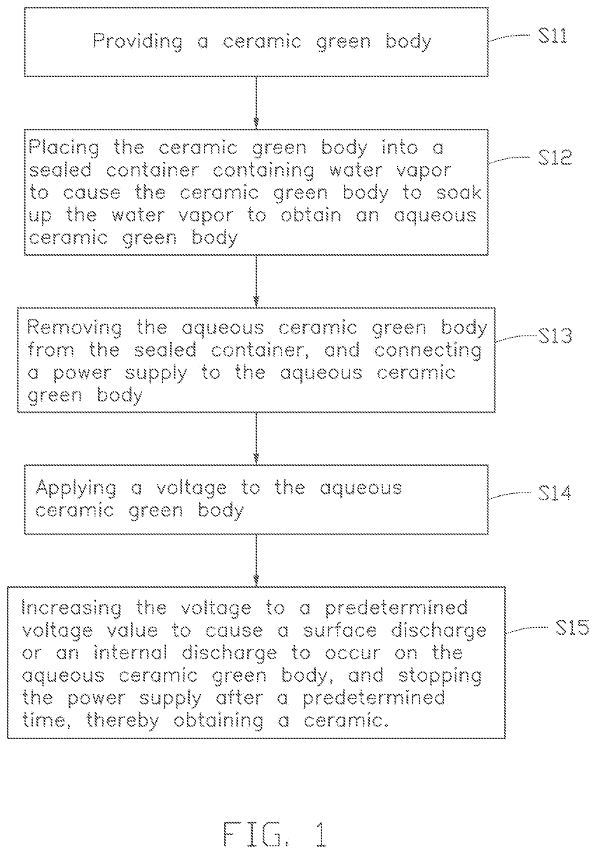

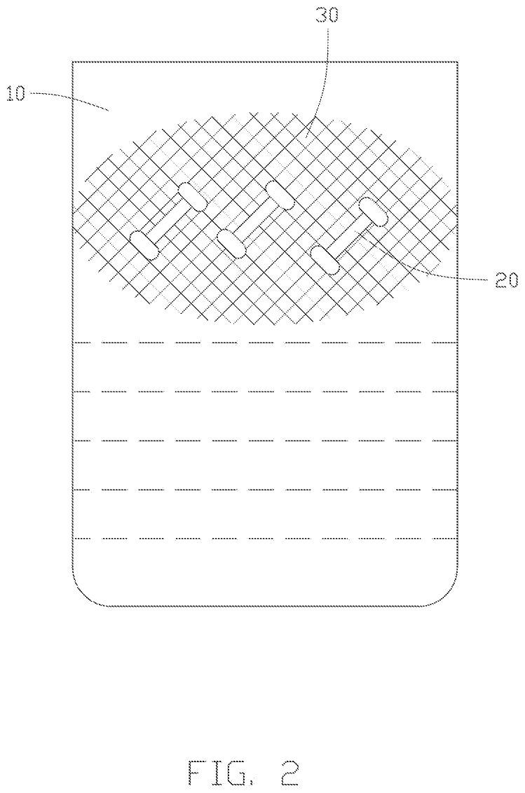

Referring to FIGS. 1 and 2, an embodiment of a method for manufacturing a ceramic includes steps as follows.

Step S11, a ceramic green body is provided.

Specifically, ceramic powders are put into a mold and are pressed to prepare a ceramic green body, and the prepared ceramic green body is put into an oven with a temperature of 110° C. to 150° C. for drying for more than 15 minutes. The dried ceramic green body is immediately weighted with a balance, and this weighing is recorded as a first weighing.

A shape of the ceramic green body is a cylinder, a cuboid, or an I-shape. It is understood that the shape of the ceramic green body may also be other regular or irregular shapes. Specifically, the ceramic green body may be any shape. In this embodiment, the ceramic green body is I-shaped. The ceramic green body may be made of zinc oxide.

In this embodiment, after providing a ceramic green body and before drying the ceramic green body, it is also necessary to form electrodes (not shown) by spraying on both ends of the ceramic green body. The electrodes are made of gold or conductive silver paste. The electrodes may also be made of a metal such as silver (Ag) or platinum (Pt) which is easily bonded to the ceramic green body. In addition, the electrodes may be made of other metals. In other embodiments, the electrodes may also be metal sheets.

Step S12, referring to FIG. 2, the ceramic green body is placed into a sealed container 10 containing water vapor to cause the ceramic green body to soak up the water vapor, thereby obtaining an aqueous ceramic green body 20.

The ceramic green body soaks up the water vapor uniformly in a device for absorbing moisture as shown in FIG. 2 to obtain the aqueous ceramic green body 20. In this embodiment, the device for absorbing moisture includes the sealed container 10 and a screen mesh 30 in the sealed container 10. The sealed container 10 contains water, and the screen mesh 30 is used for supporting the ceramic green body and the aqueous ceramic green body 20. The sealed container 10 may be a beaker covered with a plastic wrap (not shown), and a material of the screen mesh 30 may be metallic iron. Specifically, the beaker is filled with a certain amount of water, the screen mesh 30 is suspended by a thread above the water surface, the ceramic green body is placed onto the screen mesh 30, the beaker is sealed with the plastic wrap, and the beaker is heated. The humidity in the beaker increases continuously with the evaporation of water until it is saturated, so that the ceramic green body can soak up the water vapor uniformly.

Step S13, the aqueous ceramic green body 20 is removed from the sealed container 10, and a power supply 40 is connected to both ends of the aqueous ceramic green body 20.

Specifically, after a certain period of time, the aqueous ceramic green body 20 is taken out, a mass of the aqueous ceramic green body 20 is measured, and this weighing is recorded as a second weighing. Wires 50 are respectively wound on the two electrodes, and the wires 50 are connected to the power supply 40, so that the two electrodes are connected with the power supply 40.

A moisture content of the aqueous ceramic green body 20 is calculated from the mass of the second weighing and the mass of the first weighing. The moisture content of the aqueous ceramic green body 20 is a percentage of the increased mass of the aqueous ceramic green body 20 after the ceramic green body has soaked up the water vapor.

In this embodiment, the moisture content of the aqueous ceramic green body is controlled to be in a range of 3% by weight to 10% by weight. If the moisture content of the aqueous ceramic green body is less than 3% by weight, the aqueous ceramic green body 20 is put back into the sealed container 10 to soak up more moisture appropriately to increase the moisture content. If the moisture content of the aqueous ceramic green body 20 is higher than 10%, the aqueous ceramic green body 20 is heated appropriately to reduce the moisture content. The aqueous ceramic green body 20 can be placed into an oven for heating.

It can be understood that before sintering, the ceramic green body can also be placed into the closed container containing water vapor, and a relationship between the absorption of the water vapor by the aqueous ceramic green body and time can be measured and set to determine when to take out the aqueous ceramic green body.

Experimentation shows that if the moisture content of the aqueous ceramic green body 20 is lower than 3% by weight or higher than 10% by weight, the success rate of ceramic in a finished and qualifying state is relatively low, and the aqueous ceramic green body 20 is breakable or the sintered ceramic cannot be densified.

It should be noted that moisture content required by different ceramic systems (i.e. ceramic green bodies of different materials) is different. For example, a preferred moisture content of zinc oxide ceramics is in a range of 2% by weight to 7% by weight, and a preferred moisture content of zirconia ceramics is in a range of 2% by weight to 8% by weight. The moisture content required for sintering a specific ceramic green body can be determined by experiment. A criterion for judging the moisture content is that under a certain moisture content, an internal discharge or surface discharge will occur on a sample (i.e., aqueous ceramic green body) when a particular high voltage is applied.

The wires 50 are of metal with a high melting point. Specifically, the metal wires may include platinum wires. In this embodiment, the power supply 40 is a high-voltage power supply. The power supply 40 may be a DC power supply or an AC power supply. Preferably, the power supply 40 is an AC power supply. By using the AC power supply, the grains of a final sintered ceramic have better uniformity. It can be understood that the power supply 40 may also be a power supply in the form of square wave, pulse, or others.

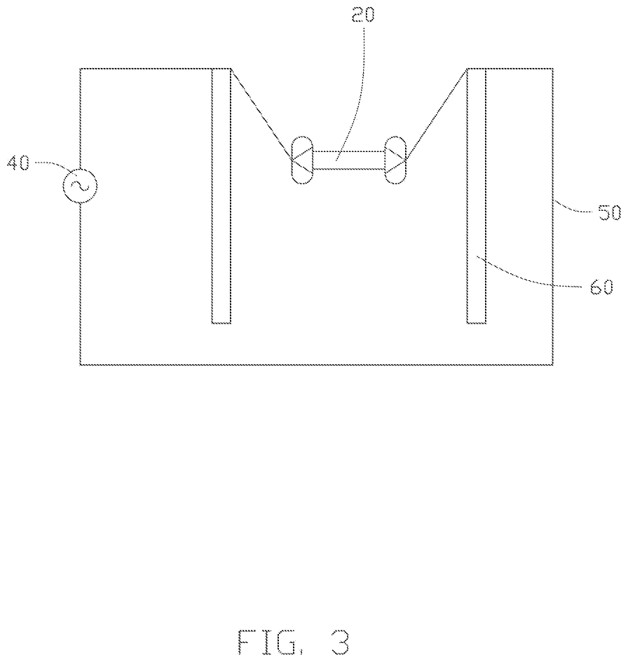

As shown in FIG. 3, in this embodiment, when the aqueous ceramic green body 20 is connected to the power supply 40, the aqueous ceramic green body 20 is suspended in isolation. Specifically, the wires 50 are fixed at upper ends of two fixing brackets 60, so that the aqueous ceramic green body 20 can be suspended between the two fixing brackets 60. The two electrodes at both ends of the aqueous ceramic green body 20 are respectively connected to the power supply 40 through the wires 50, and the aqueous ceramic green body 20 and the power supply 40 form a closed circuit through the wires 50. In other embodiments, the aqueous ceramic green body 20 may also be placed onto non-conductive ceramic plate.

Step S14, the power supply 40 is turned on to apply a voltage to the aqueous ceramic green body 20.

Step S15, the voltage is increased to a predetermined voltage value to cause a surface discharge or an internal discharge to occur on the aqueous ceramic green body 20, and the power supply 40 is stopped after a predetermined time, thereby obtaining a finished ceramic.

Specifically, the voltage is increased to the predetermined voltage value at a rate of 0.1 kV/s to 5 kV/s. The predetermined voltage value is in a range of 1 kV to 100 kV. The predetermined voltage value is not fixed, the predetermined voltage value is related to a length of the aqueous ceramic green body 20. After the voltage is increased to the predetermined voltage value, an electric field strength of the aqueous ceramic green body 10 is approximately 5 kV/cm. When the voltage is increased to the predetermined voltage value, a density of current flowing through the aqueous ceramic green body is 10 MA/mm² to 1000 MA/mm². When the current flowing through the aqueous ceramic green body 20 suddenly increases and the voltage at both ends of the aqueous ceramic green body 20 drops sharply, it can be determined that the surface discharge or internal discharge has occurred on the aqueous ceramic green body 20, which causes rapid densification of the aqueous ceramic green body 20.

It can be understood that in different ceramic systems, boost rates of voltages and densities of current flowing through the aqueous ceramic green bodies 20 may be different, and the specific value and range need to be verified by experiment.

The voltage is increased to the predetermined voltage value under the condition that the ambient temperature is less than or equal to 30° C.

As shown in FIG. 3, an apparatus for the method is provided. The apparatus is used for sintering the aqueous ceramic green body 20. The apparatus includes the power supply 40, the wires 50, and the two fixing brackets 60. The wires 50 are fixed at the upper ends of the two fixing brackets 60, so that the aqueous ceramic green body 20 can be suspended between the two fixing brackets 60. The two electrodes at both ends of the aqueous ceramic green body 20 are connected with the power supply 40 through the wires 50, and the aqueous ceramic green body 20 and the power supply 40 form a closed circuit through the wires 50.

It can be understood that the above description suggests water as an example, that is, the sintering of ceramic green body at room temperature is realized by controlling the moisture content of the ceramic green body. In other embodiments, other liquids can be used. The sintering of the ceramic green body at room temperature can be realized by controlling the amount of the liquid contained in the ceramic green body. The specific amount of other liquid is subject to experiment. The other liquid may be a volatile liquid. Specifically, such volatile liquid may be methanol, ethanol, or the like.

The present disclosure also provides a ceramic manufactured by the above method.

The present disclosure is described by way of examples and comparative examples.

### Example 1

First step, a I-shaped zinc oxide ceramic green body was placed into a beaker as shown in FIG. 2 for about 20 hours, and an aqueous ceramic green body with a moisture content of 4.32% by weight was obtained. A thickness of a middle part of the I-shaped ceramic green body is 1.7 mm, a length of the middle part is 21 mm, and a width of the middle part is 3.3 mm.

Second step, wires were wound on both ends of the aqueous ceramic green body, the wires were connected with an AC power supply, and the wires were fixed on a fixing bracket to suspend the aqueous ceramic green body.

Third step, the power supply was turned on, and a voltage was increased at a rate of 1 kV/s until the voltage at both ends of the aqueous ceramic green body suddenly drops and a current flowing through the aqueous ceramic green body suddenly rises. The levels of voltage and current were maintained, and the power supply was switched off after one minute, completing the sintering.

### Example 2

Differences from example 1 are that the ceramic green body was a cylinder with a diameter of 3 mm and a length of 22 mm, the ceramic green body was placed into the beaker for about 36 hours, the moisture content of the obtained aqueous ceramic green body reached 6.12%, and a DC power supply was used.

### Comparative Example 1

Differences from example 1 are that, in the first step, the ceramic green body was placed into the beaker for about 20 hours, and the moisture content of the obtained aqueous ceramic green body reached 1%.

### Comparative Example 2

Differences from example 1 are that, in the first step, the ceramic green body was dried at high temperature (120° C.), the moisture content of zero was applied, the ceramic green body not being placed into the beaker.

The sintered ceramics in examples 1 to 2 and comparative examples 1 to 2 were measured by the Archimedes method. The calculation results showed that a density of the sintered ceramic in example 1 was 94%, and a density of the sintered ceramic in example 2 was 95%. In the ceramic of comparative example 1, only surface discharge occurred, and although there were electric traces on the surface, there was no overall sintering and the calculated density of the ceramic was only 70%. In the ceramic of comparative example 2, only surface discharge occurred, and although there were electric traces on the surface, there was no overall sintering, and the calculated density of the ceramic was 60%, 60% represented no change compared with that before sintering.

The density of the ceramic manufactured by the method provided by the present disclosure can be as high as 90% or more, and there are no obvious defects such as cracks.

The method provided by the present disclosure realizes the sintering of ceramic green bodies at room temperature by controlling the moisture content of, and the electrical charge into, the ceramic green body, greatly reducing the temperature and energy consumption required for sintering, thereby greatly reducing the energy input required. Meanwhile, the process of the method described in the present disclosure is relatively simple. Compared with the conventional flash sintering process, no additional heating device is required, and the method of controlling the moisture content of the ceramic green body is simple and easy.

The above description represents specific embodiments of the present disclosure, but it cannot be limited to this embodiment in the actual application process. For those skilled in the art, other modifications and changes made within the principles of the present disclosure should belong to the protection scope of the present disclosure.

What is claimed is:

1. A sintering method comprising:
providing a ceramic green body;
placing the ceramic green body into a sealed container containing water vapor to cause the ceramic green body to soak up the water vapor, thereby obtaining an aqueous ceramic green body;
removing the aqueous ceramic green body from the sealed container, and connecting a power supply to the aqueous ceramic green body;
applying a voltage to the aqueous ceramic green body; and
increasing the voltage to a predetermined voltage value to cause a surface discharge or an internal discharge to occur on the aqueous ceramic green body, and stopping the power supply after a predetermined time, thereby obtaining a ceramic.

2. The sintering method of claim 1, wherein a moisture content of the aqueous ceramic green body is in a range of 3% by weight to 10% by weight

3. The sintering method of claim 1, wherein a speed of increasing the voltage to a predetermined voltage value is in a range of 0.1 kV/s to 5 kV/s.

4. The sintering method of claim 1, wherein the predetermined voltage value is in a range of 1 kV to 100 kV.

5. The sintering method of claim 1, wherein when the voltage is increased to the predetermined voltage value, a density of a current applied to the aqueous ceramic green body is in a range of 10 MA/mm² to 1000 MA/mm².

6. The sintering method of claim 1, wherein a temperature is in a range of 0° C. to 30° C., during increasing the voltage to a predetermined voltage.

7. The sintering method of claim 1, further comprising:
before placing the ceramic green body into a sealed container containing water vapor, forming electrodes on the ceramic green body, the electrodes being configured to be connected to the power supply.

8. A sintering method comprising:
providing a ceramic green body;
placing the ceramic green body into a sealed container containing a liquid, evaporating the liquid to cause the ceramic green body to absorb liquid vapor, thereby obtaining a liquid containing ceramic green body;
removing the liquid containing ceramic green body from the sealed container, and connecting a power supply to the liquid containing ceramic green body;
applying a voltage to the liquid containing ceramic green body; and
increasing the voltage to a predetermined voltage value to cause a surface discharge or an internal discharge to occur on the liquid containing ceramic green body, and stopping the power supply after a predetermined time, thereby obtaining the ceramic.

9. The sintering method of claim 8, wherein the liquid comprises methanol, ethanol, or a combination thereof.

10. The sintering method of claim 8, wherein a liquid content of the liquid ceramic green body is in a range of 3% by weight to 10% by weight.

11. The sintering method of claim 8, wherein a speed of increasing the voltage to a predetermined voltage value is in a range of 0.1 kV/s to 5 kV/s.

12. The sintering method of claim 8, wherein the predetermined voltage value is in a range of 1 kV to 100 kV.

13. The sintering method of claim 8, wherein when the voltage is increased to the predetermined voltage value, a density of a current applied to the aqueous ceramic green body is in a range of 10 MA/mm² to 1000 MA/mm².

14. The sintering method of claim 8, wherein a temperature is in a range of 0° C. to 30° C., during increasing the voltage to a predetermined.

15. The sintering method of claim 8, further comprising:
before placing the ceramic green body into a sealed container containing water vapor, forming electrodes on the ceramic green body, the electrodes being configured to be connected to the power supply.

16. A ceramic formed by sintering an aqueous ceramic green body at a temperature of 0° C. to 30° C., wherein a moisture content of the aqueous ceramic green body is in a range of 3% by weight to 10% by weight.

17. The ceramic of claim 16, wherein a grain size of the ceramic is in a range of 500 nm to 10 μm, a density of the ceramic is greater than 90%.
